(19) United States
(12) Patent Application Publication
(10) Pub. No.: US 2012/0100732 A1
(43) Pub. Date: Apr. 26, 2012

(54) ASSISTING APPARATUS FOR PLUGGING OR UNPLUGGING CONNECTOR

(75) Inventors: AN-GANG LIANG, Shenzhen City (CN); ZHENG-HENG SUN, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen (CN)

(21) Appl. No.: 12/959,295

(22) Filed: Dec. 2, 2010

(30) Foreign Application Priority Data
Oct. 20, 2010 (CN) 201010512929.4

(51) Int. Cl. H01R 13/62

(52) U.S. Cl. 439/153

(57) ABSTRACT

An assisting apparatus for plugging or unplugging a connector includes an elongated main body and a fixing portion extending from an end of the main body. A receiving space and a slot are respectively defined in a same side of the main body and the fixing portion. A stepped surface toward the slot is formed on a joint of the main body and the fixing portion. Two hooks respectively extend towards the slot from two opposite portions of the fixing portion bounding the slot.

### BACKGROUND

1. Technical Field

The present disclosure relates to an assisting apparatus for plugging or unplugging a connector.

2. Description of Related Art

With the development of electronic technology, a greater number of small-sized connectors are being used in electronic devices. However, plugging or unplugging a connector by hand can be difficult and inconvenient because of limited or cramped operating space. Furthermore, the connector or a wire connected to the connector is easily loosened or can be broken when pulling the connector out from the electronic device.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is an exploded, isometric view of an embodiment of an assisting apparatus together with a connector.

FIG. 2 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

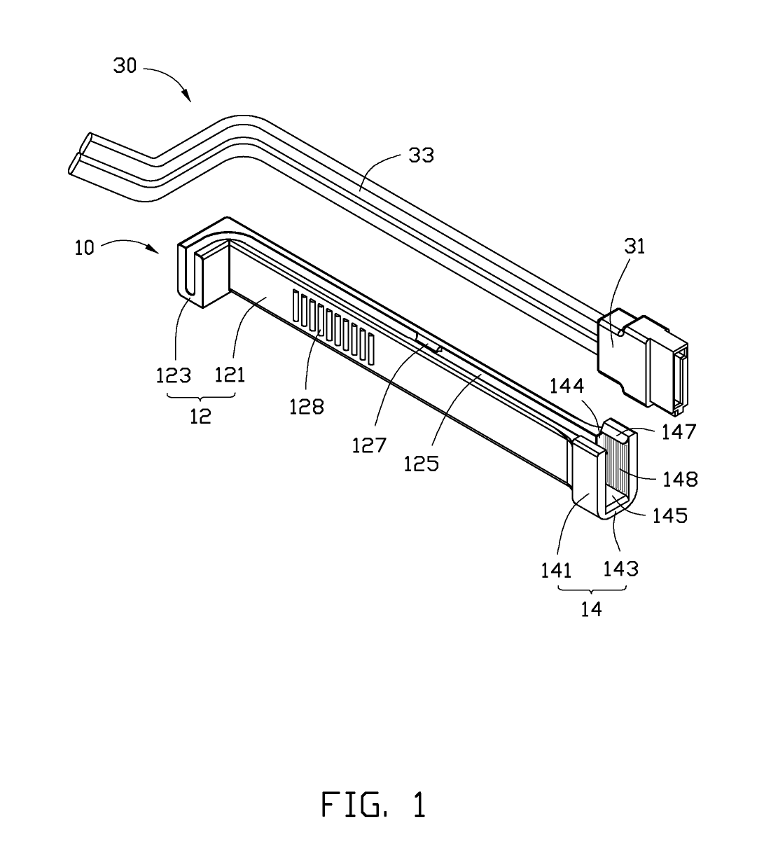

Referring to FIG. 1, an embodiment of an assisting apparatus 10 includes an elongated main body 12, and a fixing portion 14 extending from an end of the main body 12.

The main body 12 includes two opposite first side plates 121, and a second side plate 123 connected between bottoms of the first side plates 121. A receiving space 125 is bound by the first side plates 121 and the second side plate 123. A substantially wedge-shaped hook 127 extends towards the receiving space 125 from an upper portion of each first side plate 121 away from the second side plate 123. A plurality of protrusions 128 is formed on an outer surface of each first side plate 121, to provide grip assistance for easier insertion and detaching.

The fixing portion 14 is substantially U-shaped. The fixing portion 14 includes two first sidewalls 141 respectively connected to the first side plates 121 of the main body 12, and a second sidewall 143 connected to the second side plate 123 of the main body 12. A slot 145 is bound by the first sidewalls 141 and the second sidewall 143, in communication with the receiving space 125 of the main body 12. A stepped surface 144 toward the slot 145 is formed on a joint of each first sidewall 141 and the corresponding first side plate 121. A substantially wedge-shaped hook 147 extends towards the slot 145 from an upper portion of each first sidewall 141 away from the second sidewall 143. A plurality of elongated protrusions 148 is formed on an inner surface of each first sidewall 141 perpendicular to the second sidewall 143.

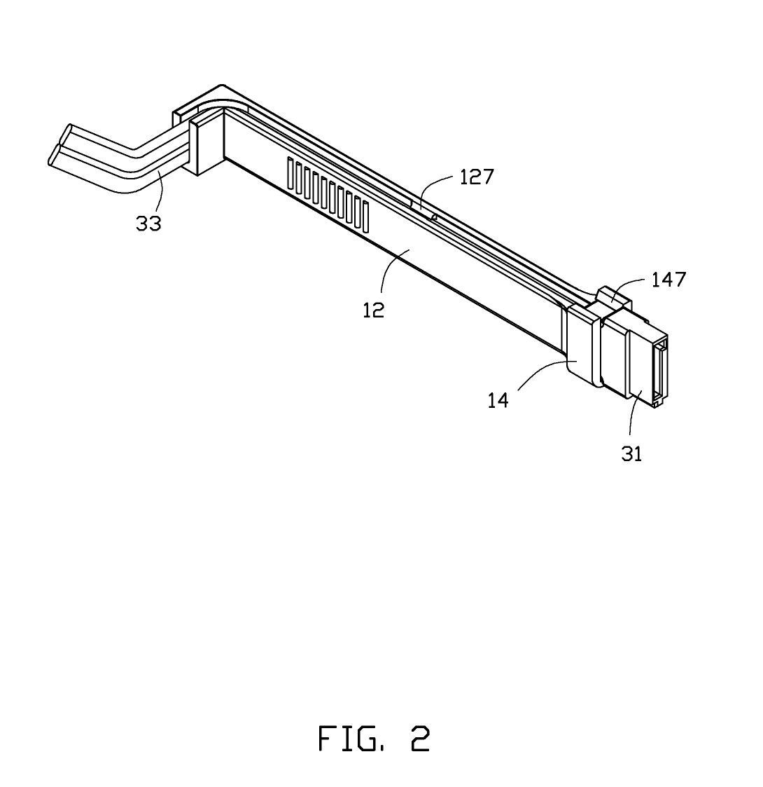

Referring to FIG. 2, to assemble a connector 30 including a plug 31 and a cable 33 to an electronic device (not shown), the connector 30 is first fixed to the assisting apparatus 10. The plug 31 of the connector 30 is inserted into the slot 145 of the fixing portion 14 from a space between the hooks 147 to deform the first sidewalls 141 outward. When the plug 31 is received in the slot 145, with an end of the plug 31 adjacent the cable 33 abutting with the stepped surfaces 144, and the opposite end of the plug 31 away from the cable 33 exposed out of the fixing portion 14, the first sidewalls 141 are restored to allow the hooks 147 to engage with a lateral side of the plug 31. Thereby, the plug 31 is fixed to the fixing portion 14. The elongated protrusions 148 inside the fixing portion 14 engage with the plug 31, and prevent the plug 31 from loosening. A portion of the cable 33 adjacent to the plug 31 is inserted into the receiving space 125 of the main body 12 from a space between the hooks 127 to deform the first side plates 121 outward. When the cable 33 is received in the receiving space 125, the first side plates 121 are restored to allow the hooks 127 to engage with a lateral side of the cable 33. Thereby, the cable 33 is fixed to the main body 12.

To plug or unplug the connector 30, the main body 12 of the assisting apparatus 10 is gripped by an operator. It is convenient to operate the connector 30, because the operation distance of the connector 30 is increased by using the assisting apparatus 10. Furthermore, because the connector 30 is received in the assisting apparatus 10, the cable 33 does not become loosened from the plug 31.

In this embodiment, the connector 30 is a serial advanced technology attachment connector.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. An assisting apparatus for plugging or unplugging a connector, the assisting apparatus comprising:
an elongated main body; and
a fixing portion extending from an end of the main body, wherein a receiving space and a slot are respectively defined in a same side of the main body and the fixing portion and communicating with each other, a stepped surface toward the slot is formed on a joint of the main body and the fixing portion, two hooks respectively extend towards the slot from two opposite portions of the fixing portion bounding the slot.

2. The assisting apparatus of claim 1, wherein a plurality of elongated protrusions is formed on an inner surface of the fixing portion.

3. The assisting apparatus of claim 1, wherein the fixing portion comprises two first sidewalls and a second sidewall connected between bottoms of the first sidewalls, the slot is bound by the first sidewalls and the second sidewall, the hooks respectively extend from upper portions of the first sidewalls away from the second sidewall.

4. The assisting apparatus of claim 3, wherein a plurality of elongated protrusions is formed on an inner surface of each first sidewall perpendicular to the second sidewall.

5. The assisting apparatus of claim 1, wherein two hooks respectively extend towards the receiving space from two opposite portions of the main body bounding the receiving space.

6. The assisting apparatus of claim 5, wherein the main body comprises two first side plates and a second side plate connected between bottoms of the first side plates, the receiving space is bound by the first side plates and the second side plate, the hooks of the main body respectively extend from upper portions of the first side plates away from the second side plate.

7. The assisting apparatus of claim 1, wherein a plurality of protrusions is formed on an outer surface of the main body.
